(19) United States
(12) Patent Application Publication
(10) Pub. No.: US 2008/0292112 A1
(43) Pub. Date: Nov. 27, 2008

(54) Method for Recording and Reproducing a Sound Source with Time-Variable Directional Characteristics

(75) Inventors: Carlos Alberto Valenzuela, Munchen (DE); Miriam Noemi Valenzuela, Munchen (DE)

Correspondence Address: HOUSTON OFFICE OF;NOVAK DRUCE AND QUIGG LLP, 1000 LOUISIANA STREET, FIFTY-THIRD FLOOR, HOUSTON, TX, 77002, US

(73) Assignee: SCHMIT CHRETIEN SCHIHIN & MAHLER, Maunchen (DE)

(21) Appl. No.: 12/095,440

(22) PCT Filed: Nov. 30, 2006
(86) PCT No.: PCT/EP2006/011496

§ 371 Date: May 29, 2008

(30) Foreign Application Priority Data
Nov. 30, 2005 (DE) 10 2005 057 406.8

(51) Int. Cl. H04R 1/40

(52) U.S. Cl. 381/97

(57) ABSTRACT

The invention relates to a method for recording sound signals of one or more sound sources located in a recording space and having time-variable directional characteristics and for reproducing the sound signals and directional information of the sound sources true to life in an area of reproduction. The invention also relates to a system for carrying out the method. In order to be able to record, transmit and reproduce the directional information of a sound source in real time, only the main direction of emission of the sound signal emitted by the sound source is detected in the recording space in a time-dependent manner and reproduction is carried out depending on the detected main direction of emission. In order to convey the directional information, the sound signals are reproduced by means of a first reproduction unit associated with the sound source and at least one second reproduction unit spaced apart from the first reproduction unit. Reproduction by means of the one or more second reproduction units proceeds with a time delay τ in relation to the first reproduction unit.

The invention relates to a method for recording sound signals of one or more sound sources located in a recording space and having time-variable directional characteristics and for reproducing the sound signals in an area of reproduction. The invention also relates to a system for carrying out the method.

Various methods are known, which attempt to record and to reproduce the impression of the sound arising in a room. The best known method is the stereo method and the further developments thereof, in which the location of a sound source is detected during the recording process and reproduced during the reproduction process. In the reproduction process however there is only a restricted region in which the location of the recorded sound source is correctly reproduced. Other reproduction methods which synthesise the recorded sound field, such as for example Wave Field Synthesis, can on the other hand reproduce the location of the sound source correctly independently of the position of the listener.

In none of these methods is temporally variable information recorded or reproduced about the direction of emission of a sound source. If sound sources with temporally variable directional characteristics are recorded, information is therefore lost. For transmitting a video conference for example, in which one participant can communicate with different participants and address them specifically, with the known methods this directional information is not detected, recorded or reproduced.

The problem addressed by the invention is to produce a method for the recording, transmission and reproduction of sound, with which the information-bearing properties of the sound sources are reproduced true to life and in particular can be transmitted in real time.

The problem is solved by means of a method for recording sound signals of a sound source located in a recording space with time variable directional characteristics using sound recording means and for reproducing the sound signals in an area of reproduction using sound reproduction means, which is characterised in that the main direction of emission of the sound signals emitted by the sound source is detected in a time-dependent manner and the reproduction takes place in a manner dependent on the detected main direction of emission.

A sound source with time variable directional characteristics can be in particular a participant of a video conference, who can address other participants and therefore speak in different directions. The emitted sound signals are recorded and their main direction of emission simultaneously detected.

The recording of the sound signals can be performed in the conventional manner with microphones or also with one or more microphone arrays. The means for detecting the main direction of emission can be of any type. In particular, acoustic means can be used. To this end, multiple microphones and/or one or more microphone arrays can be used, which detect the level and/or phase differences of the signal in different directions, from which the main direction of emission can be determined by means of a suitable signal processing system. If the position of the acoustic means, the directional characteristics thereof, and/or the position of the sound source are known, this information can be appropriately taken into account by the signal processor in determining the main direction of emission. In the same way, knowledge of the geometry of the environment and its associated sound propagation properties, as well as reflection properties can also be taken into account in determining the main direction of emission. It is particularly advantageous if information on the measured, approximated or simulated directional characteristics of the sound source can also be incorporated in determining the main direction of emission. This applies particularly in cases where the main direction of emission is only to be determined approximately, which is sufficient for many applications.

To detect the main direction of emission however, optical means can also be used, such as e.g. a video detection process with pattern recognition. In the case of participants in a video conference, it can be assumed that the speaking direction corresponds to the viewing direction. Using pattern recognition it can therefore be determined in which direction a participant is looking, and thereby the speaking direction can be determined. In particular, a combination of acoustic and optical means with appropriate signal processing can also be used. If necessary the acoustic means can also be used for recording the sound signals while simultaneously detecting the main direction of emission, and vice versa.

It is often sufficient to detect the main direction of emission approximately. A classification into 3 or 5 categories, e.g. straight, right and left or straight, diagonally to the right, right, diagonally to the left and left, can fully suffice to communicate the essential information.

The main direction of emission can advantageously be the main direction of emission in that frequency range which carries the information. To this end, the frequency range applied to determine the main direction of emission can be restricted, e.g. by using a frequency filter.

The reproduction of the sound signals should take place in accordance with the detected main direction of emission. The purpose of this is to simulate the directed emission of the original source. This can be done either by a real directed emission of the sound signal or by a simulated directed reproduction, which is perceived by the listener as directed reproduction, without it being actually physically directed in the conventional sense. The applicable methods differ among other things in the accuracy with which the directional characteristics can be reconstructed. In practice, the perceptual naturalness of the reconstruction or simulation is crucial. In the following, all such methods are summarized under the term “directed reproduction”.

In the inventive method, the reproduction of the sound signals can be carried out with a first reproduction unit associated with the sound source and at least one second reproduction unit spaced apart from the first reproduction unit. The position of this first reproduction unit in the area of reproduction can correspond to a virtual position of the sound source in the area of reproduction. The second reproduction unit(s) can be used to relay the directional information of the sound reproduction. Preferably, two second reproduction units are used, one of which can be positioned on one side and the other on the other side of the first sound reproduction unit. Instead of using a second reproduction unit on each side of the first sound reproduction unit respectively, multiple second reproduction units can be arranged respectively spaced apart from one another, preferably in each case two second reproduction units.

The sound signals recorded in the recording space of the sound source can be reproduced in the area of reproduction of a first reproduction unit, such as e.g. a loudspeaker. This loudspeaker can be placed in the area of reproduction in such a way that it is located at the virtual position of the sound source in the area of reproduction. The sound source is so to speak “attracted” into the area of reproduction. The first reproduction unit can also be generated however with multiple loudspeakers, with a group of loudspeakers or with a loudspeaker array. For example it is possible by means of wave field synthesis to place the first reproduction unit as a point source at the virtual position of the sound source in the area of reproduction, such that the sound source is virtually attracted into the area of reproduction. This is advantageous e.g. for video conferences in which as far as possible the impression of an actual conference with the presence of all participants is to be achieved. The sound source would then be a participant in the recording space. The reproduction would be carried out via a first reproduction unit, which would be placed at the point in the area of reproduction at which the participant in the recording space would be virtually present in the area of reproduction.

The information on the direction of emission can be relayed by the fact that the reproduction with the second reproduction unit(s) takes place relative to the first reproduction unit with a time delay τ relative to the first reproduction unit. This time delay can be different for each of the second reproduction units. It has been shown that information regarding the direction of emission of a sound source can be communicated to the human ear by a type of echo or reflection of the sound signal being emitted by one or more sound sources spaced apart with a small time delay. The time delay at positions for participants, at which a participant in e.g. a video conference can be placed, should have a value between 2 ms and 100 ms so that the echo or reflection is not processed as a separate sound event. The time delay τ of the second reproduction unit or units can therefore be preferably chosen such that the actual time delay between the sound signals has a value at least in partial regions of the area of reproduction between 2 ms and 100 ms, preferably between 5 ms and 80 ms and in particular between 10 ms and 40 ms.

The reproduction due to the second reproduction unit(s) can take place in accordance with the spatial characteristics of the area of reproduction with a reduced level, in particular with a level reduced by 1 to 6 dB and preferably by 2 to 4 dB. According to the directional characteristics to be simulated, before the reproduction by the second reproduction unit(s) the sound signal can also be processed with a frequency filter, for example a high-pass, low-pass or band pass filter. The parameters of the frequency filter can be either fixed in advance or be controlled depending on the main direction of emission.

The second reproduction unit(s) can, as can the first reproduction unit also, be one or more loudspeakers or a virtual source, which is generated with a group of loudspeakers or with a loudspeaker array, for example using wave field synthesis.

For the best possible true to life reproduction of the information about the direction of emission of a sound source, the reproduction level of the first and second reproduction units can also be adapted depending on the directional characteristics to be simulated. For this purpose the reproduction levels are adjusted such that the perceivable loudness differences resulting from the directional characteristics can be appropriately approximated at different listener positions. The reproduction levels of the individual reproduction units determined in this way can be defined and stored for different main directions of emission. In the case of time variable directional characteristics, the detected main direction of emission then controls the reproduction levels of the individual reproduction units.

The method described above can of course also be applied to multiple sound sources in the recording space. For the reproduction of multiple sound sources with the described method it is particularly advantageous to have the sound signals of the individual sound sources to be transmitted provided separately from one another. Different methods for recording the sound signals are therefore conceivable. For recording the sound signals, sound recording means can be associated with the individual sound sources. This association can either be 1:1, so that each sound source has its own sound recording means, or so that groups of multiple sound sources are associated to one sound recording means respectively. The position of the active sound source at a given moment can be determined both with conventional localisation algorithms and also with video acquisition and pattern recognition. In synchronous sound emission from more than one sound source, with a grouping of the sound sources to one sound recording means, the sound signals of the individual sound sources can be separated from each other with conventional source separation algorithms such as for example “Blind Source Separation”, “Independent Component Analysis” or “Convolutive Source Separation”. If the position of the sound sources to be recorded is known, as a sound recording means for a group of sound sources a dynamic direction-selective microphone array can also be used, which processes the received sound signals according to the pre-specified positions and combines them together for each sound source separately.

The detection of the main direction of emission of the individual sound sources can be done on the same principles as described for one sound source. To do this, appropriate means can be associated with the individual sound sources. The association can be such that each sound source has its own direction sensing means, or in such a way that groups of multiple sound sources are associated to one direction sensing means. In grouped sound sources the detection of the main direction of emission occurs as for the case of one sound source, when at the given point in time only one sound source is emitting sound. If two or more sound sources emit sound, then in the first processing step of the direction sensing means the received signals (for example sound signals or video signals) are first associated with the corresponding sound sources. In the case of optical means, this can be done using object recognition algorithms. In the case of acoustic means, the sound signals of the sound sources recorded separately with the previously described sound recording means can be used for associating the received signals to the corresponding sound sources. When the position of the sound sources is known, the transmission function between the sound sources and the acoustic direction sensing means can preferably be taken into account, as well as the directional characteristics of both the direction sensing means and the sound recording means. Only after the assignment of the received signals to the relevant sound sources is the main direction of emission determined separately for the individual sound sources, for which purpose the same methods described above for one sound source can be used.

The quality of the reproduction can be improved by suppressing sound signals from a sound source which are received by recording means, or direction sensing means, not associated with the sound source, using acoustic echo cancellation or cross talk cancellation. The minimisation of acoustic reflections and extraneous noises with conventional means can also contribute to improving the reproduction quality.

For reproducing the sound signals, a first reproduction unit can be associated with each sound source. This association can take place either on a 1:1 basis, so that each sound source has its own first reproduction unit, or in such a way that groups of multiple sound sources are associated to one reproduction unit. Depending on the association, the spatial information reproduced in the area of reproduction is more or less accurate.

As an alternative to the above described reproduction technique the reproduction can also be carried out using wave field synthesis. For this purpose, instead of the point source normally used, the directional characteristics of the sound source must be taken into account for synthesising the sound field. The directional characteristics to be used for this are preferably stored in a database ready for use. The directional characteristics can be for example a measurement, an approximation obtained from measurements, or an approximation described by a mathematical function. It is equally possible to simulate the directional characteristics using a model, for example by means of direction dependent filters, multiple elementary sources or a direction dependent excitation. The synthesis of the sound field with the appropriate directional characteristics is controlled using the detected main direction of emission, so that the information on the direction of emission of the sound source is reproduced in a time dependent way. The method described above can of course also be applied to multiple sound sources in the recording space.

As well as the reproduction techniques described up to now, a multi-loudspeaker system (multi-speaker display device) known from the prior art can also be used for the directed reproduction of the sound signals, the reproduction parameters of which are also controlled by the main direction of emission determined in a time dependent way. Instead of controlling the reproduction parameters, control of a rotatable mechanism is also conceivable. If there are multiple sound sources present in the recording space, in the area of reproduction for each sound source a multi-loudspeaker system can be provided.

Other known reproduction methods from the prior art can also be used for the directed reproduction of the sound signals, the reproduction parameters of which in order to do this must be controlled according to the main direction of emission determined in a time dependent manner.

A further problem addressed by the invention is to create a system which facilitates the recording, transmission and true to life reproduction of the information-bearing properties of the sound sources.

The problem is solved using a system for recording sound signals from one or more sound sources with time variable directional characteristics with sound recording means in a recording space and for reproducing the sound signals with sound reproduction means in an area of reproduction, which is characterised in that the system has means for detecting, in a time dependent manner, the main directions of emission of the sound signals emitted by the sound source(s) and means for reproducing the transmitted sound signals in dependence on the detected directions.

The system can have at least two sound recording units associated with a sound source for recording the sound signals emitted by this sound source and the main direction of emission thereof. Alternatively or additionally to this the system can also have optical means for detecting the main direction of emission thereof.

Means for detecting the main direction of emission can be e.g. microphones or microphone arrays or means for video acquisition, in particular with pattern recognition.

The reproduction of the sound signals can be carried out with a first reproduction unit associated with the sound source and at least one second reproduction unit spaced apart from the first reproduction unit. The position of this first reproduction unit in the area of reproduction can correspond to a virtual position of the sound source in the area of reproduction.

Reproduction with the second reproduction unit or units can be done with a time delay τ relative to the first reproduction unit for subjectively generating a directed emission of sound. In the case of multiple second reproduction units an individual time delay can be chosen for each one.

The system can be used for e.g. sound transmission in video conferences. In this case there are specified positions at which participants in the conference remain. Depending on the participants' positions the time delay τ of the second reproduction unit or units can be chosen in such a way that the actual time delay between the sound signals at least at the positions of the respective participants in the area of reproduction lies between 2 ms and 100 ms, preferably between 5 ms and 80 ms and in particular between 10 ms and 40 ms.

The reproduction using the first and/or the second reproduction unit(s) can be carried out at a reduced level, in particular at a level reduced by 1 to 6 dB and preferably by 2 to 4 dB, and/or in particular in accordance with the main direction of emission.

It is self-explanatory that the system for transmitting the sound signals of one sound source can be extended to the transmission of the sound signals of multiple sound sources. This can be done by simply increasing the number of the means previously described. It can be advantageous however to reduced the required means in such a way that certain means are associated with multiple sound sources on the recording side. Alternatively or additionally reproduction means can also have multiple associations on the reproduction side. The association possibilities for the inventive method described above also apply analogously to the system. In particular the number of sound recording units and/or sound reproduction units can correspond to the number of sound sources plus 2.

Additional embodiments of the method and the system are disclosed in the sub claims.

There follows a detailed description of the invention with reference to the attached illustrations and with the aid of selected examples:

FIG. 1 shows a microphone array;

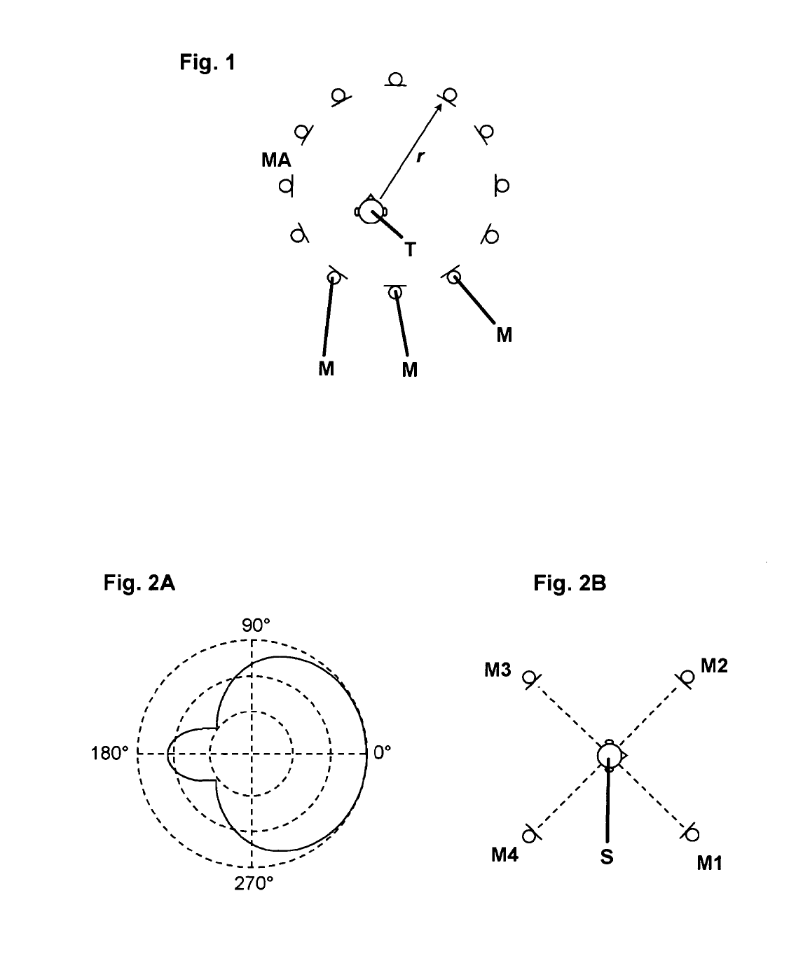

FIGS. 2A and B describe a simplified acoustic method for determining the main direction of emission of a sound source;

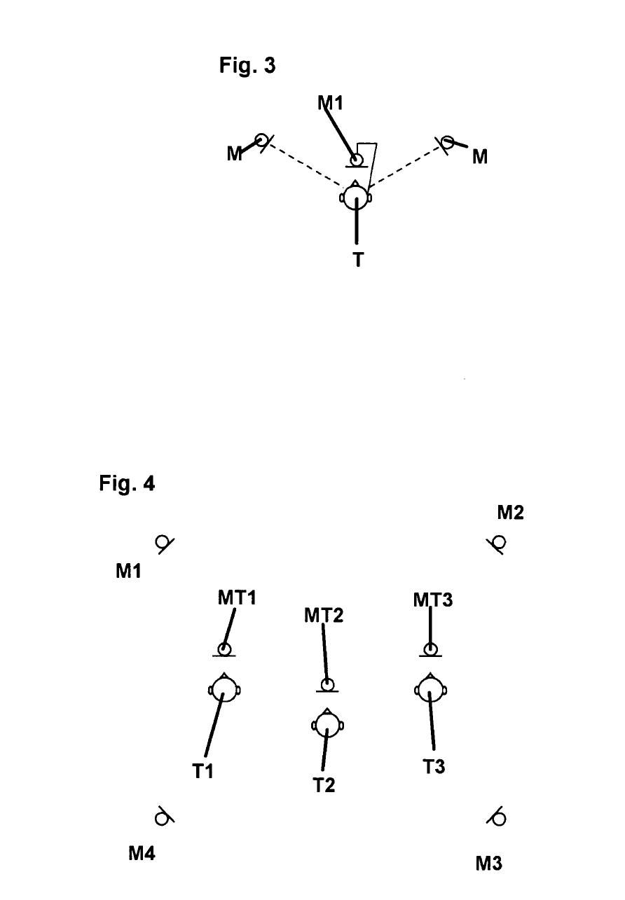

FIG. 3 shows the determination of the main direction of emission of a sound source with the aid of a reference sound level;

FIG. 4 shows a method of sensing direction for multiple sound sources in the recording space;

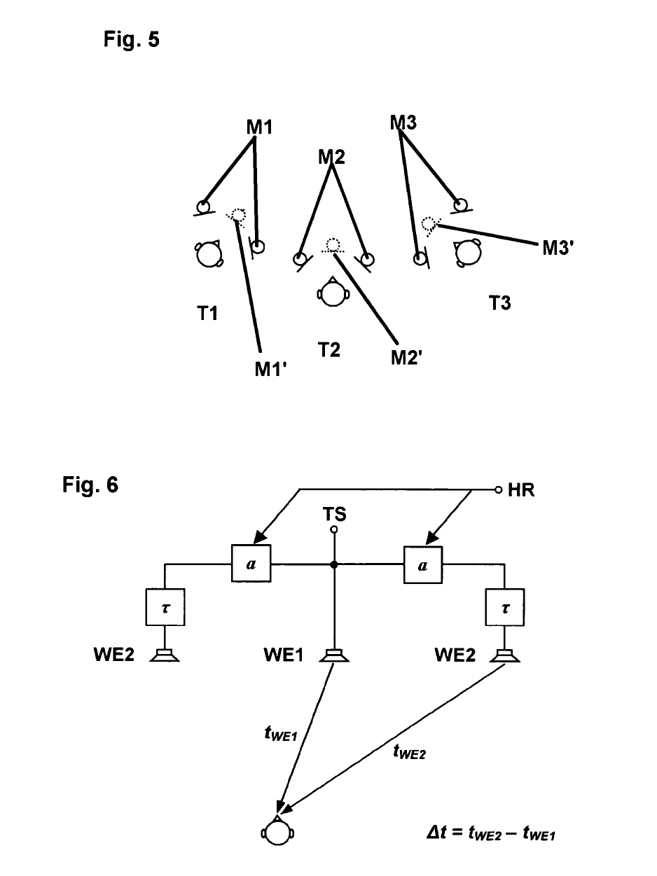

FIG. 5 shows a method in which each sound source uses its own direction sensing means;

FIG. 6 shows a reproduction method for one sound source with a first reproduction unit and at least one second reproduction unit, spaced apart;

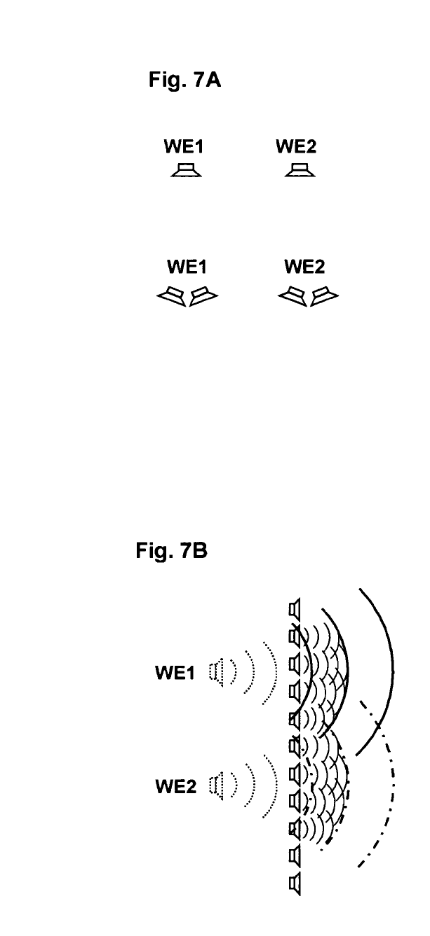

FIGS. 7A and 7B show various methods of realising the first and second reproduction units;

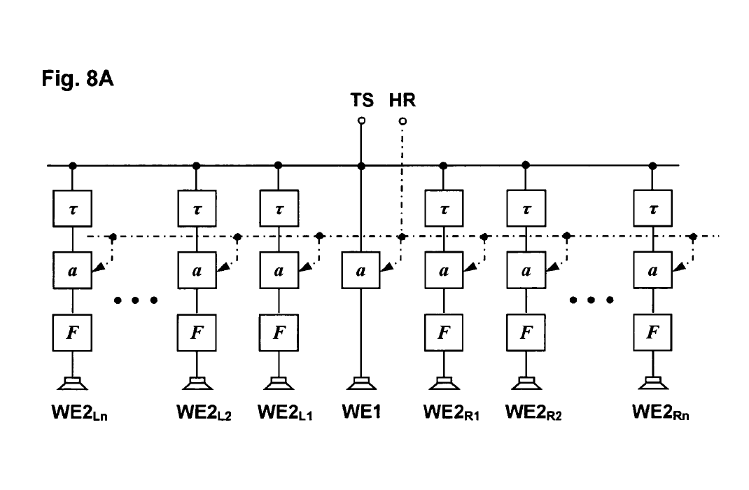

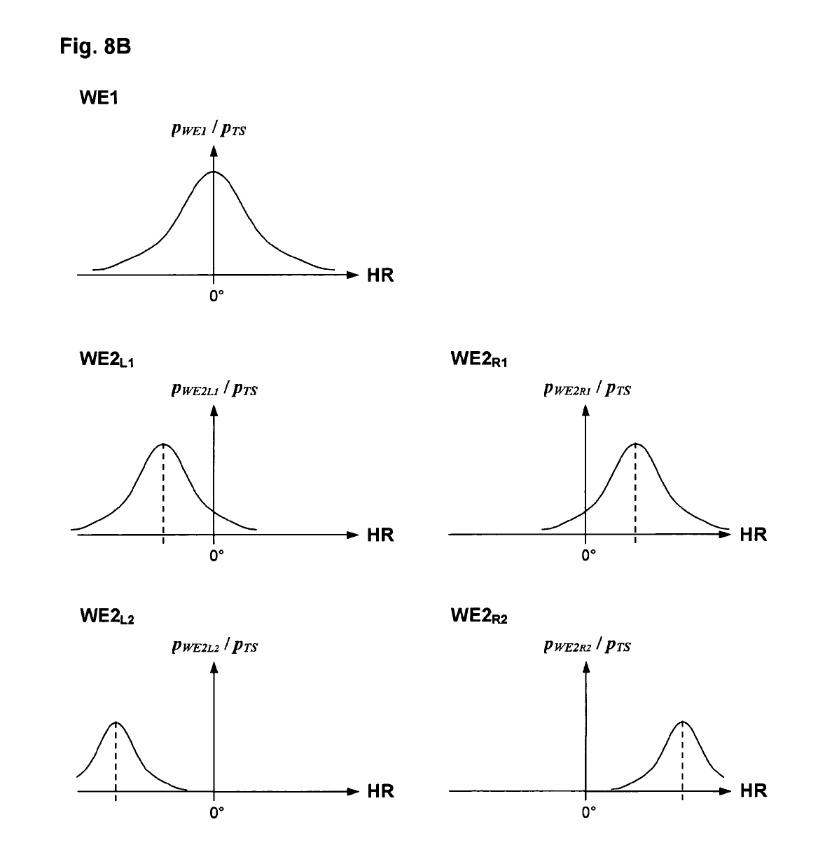

FIGS. 8A and 8B show reproduction methods for one sound source with a first reproduction unit and multiple second reproduction units spaced apart from each other;

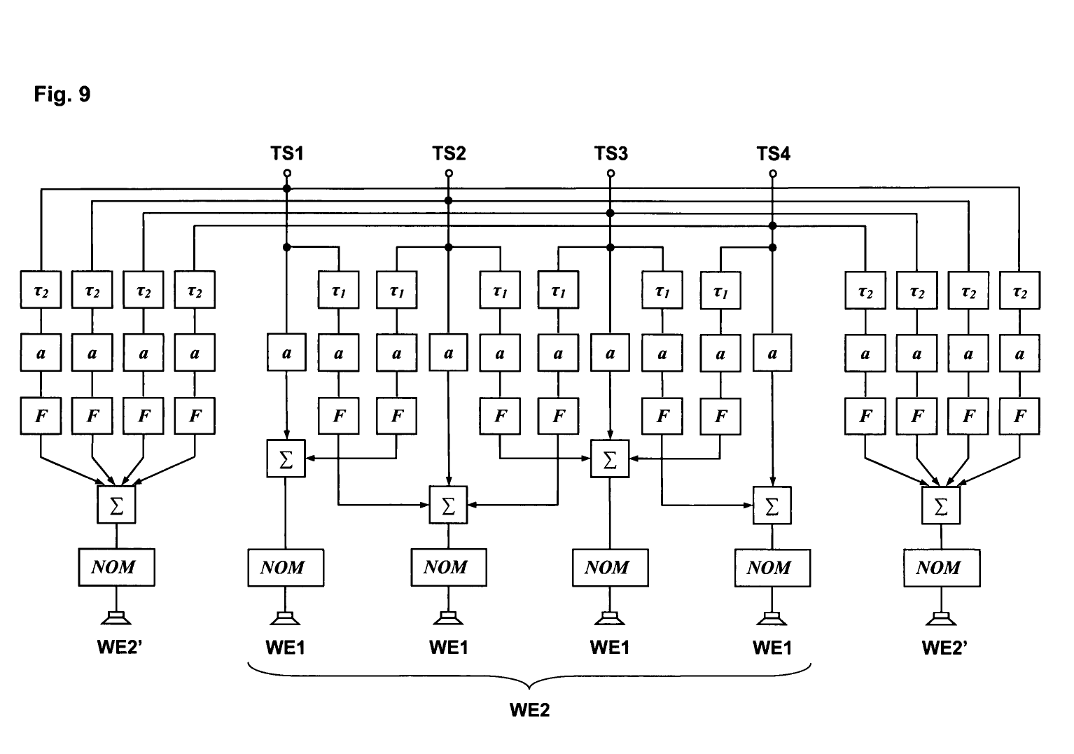

FIG. 9 shows a reproduction method for multiple sound sources with overlapping first and second reproduction units;

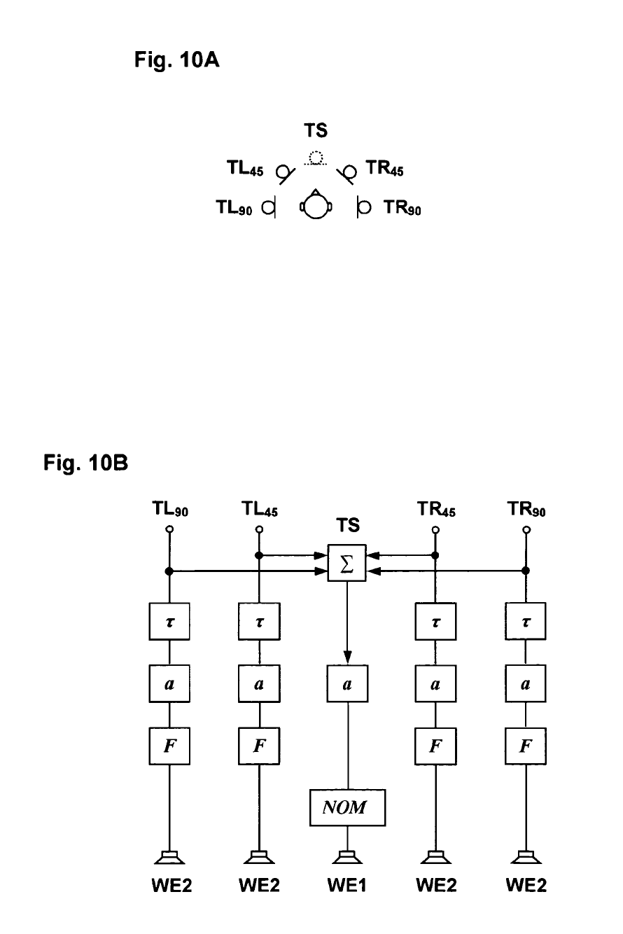

FIGS. 10A and 10B show a simplified reproduction method for a direction detection according to FIG. 5.

The microphone array MA illustrated in FIG. 1 is used for detecting the main direction of emission of a sound source T in the recording space.

The main direction of emission of a sound source T is determined with a microphone array MA, that is, a plurality of single microphones M connected together. For this purpose the sound source T is surrounded with these microphones MA in an arbitrary arrangement, for example in a circle, as shown in FIG. 1.

In a first step the position of the sound source T with respect to the microphones M is determined, such that all distances r between sound source T and microphones M are known. The position of the sound source T can be specified for example by measurement or with a conventional localisation algorithm. It can be advantageous for specifying the position to use corresponding filters to consider only those frequency ranges which have no marked preferred direction with respect to the sound emission. In many cases this applies to low frequency ranges, in the case of speech for example below about 500 Hz.

The main direction of emission of the sound source T can be determined from the sound levels detected at the microphones M, wherein the different sound attenuation levels as well as transit time differences due to the different distances r between the individual microphones M and the sound source T are taken into account. With direction selective microphones M, the directional characteristics of the microphones M can also be taken into account when determining the main direction of emission.

The more directions are detected by microphones, the more precisely the main direction of emission can be determined. Conversely, the number of necessary microphones can be reduced, (a) when the main direction of emission is only to be detected approximately, for example a classification into 3 or 5 categories may be completely sufficient, and accordingly an arrangement of the direction detecting means in these directions is sufficient, or (b) when the main direction of emission is restricted to a limited angular range; for example the speaking direction in teleconferencing will normally be restricted to an angular range in the forward direction.

The microphones can be used as means for direction detection and also as sound recording means for recording the sound signals from the sound source. Using the position of the sound source and where appropriate also using the determined main direction of emission, a weighting can be defined for the microphones, which regulates the contribution of the individual microphones to the recorded sound signal.

FIGS. 2A and 2B show a simplified acoustic method for determining the main direction of emission of the sound source relative to the method of FIG. 1.

Instead of the relatively costly method of FIG. 1, a very much simpler method for determining the main direction of emission can also be used, which also determines the sound levels in different directions with the corresponding corrections according to the same principle as in FIG. 1. The main direction of emission however is determined by a comparison of the detected level ratios in the different directions with a pre-specified reference. If the directional characteristics of the sound source are present in the form of a measurement, an approximation obtained from measurements, a mathematical function, a model or simulation or in similar form, then this can be used as a reference for determining the main direction of emission. Depending on the complexity of the approximation of the directional characteristics of the sound source selected as the reference, only few microphones are then necessary for detecting the main direction of emission. The accuracy and hence complexity of the reference depends on how accurately the main direction of emission is to be determined; if a coarse determination of the main direction of emission is adequate, a very much simplified reference can be chosen. The number and position of the microphones for detecting the sound levels in different directions must be chosen such that together with the reference the directions sampled therewith are sufficient to unambiguously determine the position of the directional characteristics of the sound source with respect to the microphones.

If one uses a highly simplified reference for the directional characteristics in the case of speech signals for example, as shown schematically by way of example in FIG. 2A, then the main direction of emission can be determined sufficiently accurately with at least 3, and preferably 4 microphones, which are so positioned that they each include an angle of 60°-120°. FIG. 2B shows an example in which the 4 microphones M₁ to M₄ each include an angle of 90°.

If the possible main directions of emission are restricted to a specific angular range, then the reference shown in FIG. 2A can also be simplified even further. For example a main direction of emission directed backwards can be ruled out in conferences, if no participant are seated behind each other. In this case the reference of FIG. 2A can be simplified in such a way that the peak pointing backwards is not considered, i.e. only an approximately kidney-shaped directional characteristic is taken as the reference. In this case 2 microphones enclosing an angle of 60°-120° are sufficient to detect the main direction of emission sufficiently accurately. For example, in FIG. 2B the two microphones M₃ and M₄ positioned behind the speaker S can be dispensed with.

The approximation of the directional characteristics of speech with one of the two reference patterns described above has proved to be adequate for many applications, in particular for conferencing applications in which a relatively coarse determination of the main direction of emission is adequate for a natural reconstruction. For a more accurate determination of the main direction of emission, in a videoconference application the one or more optical means with pattern recognition can also be used. It is also possible using upstream frequency filters to limit the determination of the main direction of emission to the information-bearing frequency ranges.

As in FIG. 1 the microphones intended for the direction detection can also be used simultaneously as sound recording means for recording the sound signals of the sound source.

FIG. 3 illustrates the determination of the main direction of emission of a sound source with the aid of a reference sound level. The main direction of emission of a sound source T can be determined using a set of directional characteristics of the sound source available as a reference and using a current reference sound level of the sound source in a known direction. In comparison to the method explained in FIG. 2, this method can be used to determine the main direction of emission using significantly fewer microphones M, even in cases where more complex references are given for the directional characteristics. With the aid of the reference sound level in the known direction, the attenuation factors relative to this can be determined in the directions specified by the microphones M. Naturally, in this method the necessary corrections with respect to the distance from the microphones M to the sound source T, and the directional characteristics of the microphones must also be taken into account. In the case of the correction, knowledge of the geometry of the surroundings and the associated sound propagation conditions, as well as reflection properties can also be called upon. A comparison of the relative attenuation factors determined in this way with the actual directional characteristics of the sound source T as a reference yields the main direction of emission.

The reference sound level can be detected for example with a clip-on microphone M₁, which constantly follows the changes in direction of the sound source T, so that the direction of the sound signals detected therewith is always constant and therefore known. It is advantageous if the direction of the reference sound level is the same as the main direction of emission. The microphone M₁ which is used for determining the reference sound level can also be used simultaneously as an acoustic means for recording the sound signals.

If for example the approximation shown in FIG. 2A is available as a reference for the directional characteristics of a speech signal, then the main direction of emission of the sound source can be determined relatively precisely with only 2 direction sensing microphones M, which enclose an angular range of approx. 60°-120°, and the microphone M₁ for determining the reference sound level.

In this method also, the determination of the main direction of emission can be restricted to the information-bearing frequency ranges by using appropriate frequency filters.

In FIG. 4, a method for detecting direction with multiple sound sources in the recording space is shown. The individual main directions of emission of multiple sound sources T₁ to T₃ in the recording space are determined with a single direction sensing acoustic means, which is associated with all sound sources present.

If, as shown in FIG. 4, multiple sound sources T are present in the recording space, the determination of the main direction of emission of each individual sound source can be carried out with the same methods as described earlier for a single sound source. To do this however, the sound signals of the individual sound sources Tₓ must be separate from each other for the detection of their directions. This is automatically the case, when only one sound source emits sound at a given point in time. If two or more sound sources emit sound at the same time however, the sound signals of the individual sound sources, which are all received simultaneously by the microphones M₁ to M₄ of the direction detection means, must be separated from each other in advance for the detection of their directions with a suitable method. The separation can be done for example with a conventional source separation algorithm. It is particularly simple to associate the sound signals to the corresponding sound sources, if the separated sound signals of the sound sources are known as reference signals. These reference signals are obtained for example when an acoustic means, e.g. a microphone M_{T1}, M_{T2} and M_{T3}, is used, as shown in FIG. 4, for recording the sound signals for each sound source separately. All sound signals which do not belong to the associated sound source, the main direction of emission of which is to be determined, are suppressed for the purposes of determining the direction. The separation of the sound signals using the reference signals can be improved by also taking into account the different transfer functions which come about for the microphones of the direction sensing means (M₁ to M₄) and for means specified for recording the sound signals (M_{T1}, M_{T2} and M_{T3}) .

In the example illustrated in FIG. 4 the separate detection of the main direction of emission of the individual sound sources takes place with a direction sensing means according to the method shown in FIG. 2. As explained there, the direction sensing means can consist of 4 microphones enclosing an angular range of approx. 60°-120°; but it is also possible to use just the 2 microphones placed in front of the participants.

FIG. 5 shows a method in which each sound source uses its own direction sensing acoustic means. To detect the main directions of emission of multiple sound sources T₁ to T₃ in the recording space, each sound source can be associated with its own direction sensing means M₁ to M₃. Since each sound source has its own acoustic means for detecting the direction, in this type of method no separation between the sound signals and the associated sound sources is necessary. In the example shown in FIG. 5 the main direction of emission of each sound source is determined with the method shown in FIG. 2. Since in many conferencing applications, in particular also in video conferences, a backwards speaking direction can mostly be ruled out, 2 microphones are sufficient to determine the main direction of emission of a sound source with adequate accuracy.

The recording of the sound signals of the sound sources in FIG. 5 optionally takes place with an additional microphone M₁′ to M₃′ per sound source, which is associated with each sound source T₁ to T₃, or the direction sensing microphones M₁ to M₃ are also simultaneously used for recording the sound signals.

In FIG. 6 a reproduction method is shown for a sound source with a first reproduction unit and at least one second reproduction unit spaced apart.

The sound signals TS of a sound source recorded in the recording space can be reproduced in the area of reproduction with a first reproduction unit WE1 assigned to the sound source. The position of the first reproduction unit WE1 can be chosen to be the same as the virtual position of the sound source in the area of reproduction. For a video conference this virtual position can be for example at the point in the room where the visual representation of the sound source is located.

To communicate the directional information of the sound reproduction, at least one second reproduction unit WE2 spaced apart from the first reproduction unit is used. Preferably two second reproduction units are used, one of which can be positioned on one side and the other on the other side of the first reproduction unit WE1. Such a design allows changes in the main direction of emission of the sound source in an angular range of 180° around the first reproduction unit to be simulated, i.e. around the virtual sound source positioned at this point. The information on the direction of emission can be communicated by the fact that the reproduction with the second reproduction units is delayed relative to the first reproduction unit. The time delay τ used should be chosen so that the actual time delay Δt=t_{wE2}−t_{wE1} between the sound signals has a value at least in sub-regions of the area of reproduction between 2 ms and 100 ms, so that for the receivers, i.e. for example for the receiving participants of the video conference, who are located in these sub-regions, the actual time delay lies between 2 ms and 100 ms.

The main direction of emission HR detected in the recording space controls the reproduction levels at the second reproduction units via an attenuator a. In order to simulate a main direction of emission of the sound source for example, which is directed towards the right side of the room, the sound signals to the second reproduction unit, which is located on the left, are completely attenuated and only reproduced via the right-hand second reproduction unit delayed relative to the first reproduction unit.

The method described above can of course also be applied to multiple sound sources in the recording space. For this purpose correspondingly more first and second reproduction units must be used.

FIGS. 7A and 7B show different methods for implementing the first and second reproduction units.

The first and also the second reproduction units WE1 and WE2 can, as shown in FIG. 7A, each be implemented with a real loudspeaker or a group of loudspeakers at the corresponding position in the room. They can however also each be implemented with a virtual source, which is placed for example using wave field synthesis at the appropriate position, as shown in FIG. 7B. Naturally a mixed implementation using real and virtual sources is also possible.

In FIGS. 8A and 8B a reproduction method is shown for a sound source with a first reproduction unit and multiple second reproduction units, spaced apart from each other.

The basic method described in FIG. 6 can be supplemented with the extensions described in the following, in order to reproduce the directional information of the sound source as faithfully as possible.

One possibility is, instead of a second reproduction unit on each side of the first reproduction unit WE1, to use multiple second reproduction units WE2 spaced apart, as shown in FIG. 8A. The delays τ to the individual reproduction units WE2 can be chosen individually for each reproduction unit. It is particularly advantageous for example, with increasing distance from the reproduction units WE2 to the reproduction unit WE1, to select shorter values for the corresponding delays. When doing so however, as explained with regard to FIG. 6, it must be borne in mind that the actual time delay between the sound signals, at least in sub-regions of the area of reproduction, must lie between 2 ms and 100 ms, preferably between 5 ms and 80 ms, and in particular between 20 ms and 40 ms.

As shown in FIG. 8A, corresponding to the directional characteristics of the sound source to be simulated, the sound signal TS can be additionally processed, prior to the reproduction by the second reproduction unit(s) WE2, with a filter F, for example a high-pass, low-pass or band-pass filter.

For the best possible true to life reproduction of the information about the direction of emission, the reproduction level of the first and second reproduction units can also be adapted depending on the directional characteristics to be simulated. For this purpose the reproduction levels are adjusted using an attenuator a, such that the perceivable loudness differences at different listener positions resulting from the directional characteristics can be appropriately approximated. The attenuations thus determined for the individual reproduction units can be defined and stored for different main directions of emission HR. In the case of a sound source with time variable directional characteristics, the detected main direction of emission then controls the reproduction levels of the individual reproduction units.

In FIG. 8B examples of the attenuation functions are shown for one first and two second reproduction units on each side of the first reproduction unit (WE1, WE2_{L1}, WE2_{L2}, WE2_{R1}, WE2_{R2}) depending on the main direction of emission HR, in a form in which they can be stored for controlling the directed reproduction. For the sake of simplicity, instead of the logarithmic level values, the sound pressure of the corresponding reproduction unit is shown in relation to the sound pressure of the sound signal p_{TS}. Depending on the main direction of emission HR that is detected and transmitted, the attenuators a of the respective reproduction units are adjusted according to the stored default value. In the example shown it should be paid attention that for every possible main direction of emission the value of the level of the first reproduction unit is either greater than or equal to the corresponding level values of the second reproduction units, or maximally 10 dB, or better 3 to 6 dB smaller than, the corresponding level values of the second reproduction units.

The method described above can of course also be applied to multiple sound sources in the recording space. For this purpose correspondingly more first and second reproduction units must be used.

In FIG. 9 a reproduction method for multiple sound sources with overlapping first and second reproduction units is shown.

If multiple sound sources are present in the recording space, the sound signals of the sound sources, as explained in regard to FIGS. 6 and 8, can be reproduced with first and second reproduction units in the area of reproduction. The number of necessary reproduction units can however be markedly reduced, if not every sound source is provided with its own first and second reproduction units. Instead, the reproduction units can be used simultaneously both as first and second reproduction units for different sound sources. It is particularly advantageous to associate a first reproduction unit, which is located at the virtual position of the respective sound source in the area of reproduction, to every sound source. As second reproduction units for a sound source, the first reproduction units of the adjacent sound sources can then be used. In addition, further reproduction units can also be deployed which are used exclusively as second reproduction units for all or at least part of the sound sources.

In FIG. 9 an example with four sound sources is shown, in which a first reproduction unit, and on each side of the first reproduction unit, apart from two exceptions, two further second reproduction units are associated with each sound source. The sound signals TS1, TS2, TS3 and TS4 of the four sound sources are reproduced with the first reproduction units WE1 assigned to them, which are placed at the corresponding virtual positions of the sound sources in the area of reproduction. The first reproduction units WE1 are also used as second reproduction units WE2 for the adjacent sound sources at the same time. The time delays τ₁ of these second reproduction units are preferably chosen such that the actual time delays between the sound signals at least in sub-regions of the area of reproduction lie in the range of 5 ms to 20 ms. In addition, two more second reproduction units WE2′ are provided in this example, which are used exclusively as second reproduction units for all four sound sources. The time delays τ₂ of these second reproduction units are adjusted so that the actual time delays between the sound signals at the receivers, i.e. for example at the receiving participants of a video conference, lie between 20 ms and 40 ms in the area of reproduction.

As shown in FIG. 8, the main directions of emission HR of the sound sources that are detected in the recording space control the reproduction levels of the first and second reproduction units via the respective attenuators a. It is naturally also possible to additionally process the sound signals with a filter F, wherein the filter can be chosen individually for each sound signal or for each reproduction unit WE2 or WE2′. Since the number of summed sound signals reproduced via one reproduction unit can vary, it is advantageous to normalise the reproduction level according to the current amount with a normalisation branch NOM.

FIGS. 10A and 10B show a simplified reproduction method for a direction detection according to FIG. 5. In this method each sound source is associated with its own, direction sensing acoustic means.

As explained with regard to FIG. 5, to detect the main directions of emission of multiple sound sources in the recording space, a direction sensing means can be associated to each sound source. In this case the reproduction of the directions of emission—using first and second reproduction units—can be done directly with the sound signals detected in different directions of the corresponding sound source. In the following exemplary embodiment an example of this reproduction method is explained with the aid of one sound source. For multiple sound sources the method must be extended according to the same principle, wherein the technique explained in example 9 of the overlapping reproduction units can be used in order to reduce the necessary number of first and second reproduction units.

In FIG. 10A the sound source is shown with the means for detecting the main direction of emission assigned thereto and with the optional microphone for recording the sound signal TS in the recording space. To detect the direction of emission, in this example four microphones are used, which record the sound signals TR₉₀, TR₄₅, TL₉₀ and TL₄₅. For recording the sound signal TS of the sound source, either a microphone of its own can be provided, or the sound signal is formed from the recorded sound signals of the direction sensing means during the reproduction, as shown in FIG. 10B.

In FIG. 10B the reproduction method is illustrated using first and second reproduction units. For conveying the directional information the sound signals TR₉₀, TR₄₅, TL₉₀ and TL₄₅ recorded with the direction sensing means are directly reproduced via the corresponding second reproduction units WE2, delayed with respect to the sound signal TS. The time delays τ can be chosen as explained in the preceding examples. Since the direction dependent level differences are already contained in the recorded sound signals from the direction sensing means, the level control of the second reproduction units by the main direction of emission is not necessary; the attenuators a are therefore only optional. The sound signals can be additionally processed with a filter F before reproduction by the second reproduction units WE2 according to the directional characteristics to be simulated.

The reproduction of the sound signal TS of the sound source takes place via the first reproduction unit. The sound signal TS can either be the sound signal recorded with its own microphone, or it is formed from the sound signals TR₉₀, TR₄₅, TL₉₀ and TL₄₅, e.g. by the largest of these sound signals or the sum of the four sound signals being used. In FIG. 10B the formation of the sum is shown as an example.

It is true that the sound quality of the reproduction method described can be affected by comb filter effects; nevertheless the method can be of great benefit in some applications due to its simplicity.

1-16. (canceled)

17. A method for recording sound signals of a sound source with time variable directional characteristics arranged in a recording space with sound recording means and for reproducing the sound signals in an area of reproduction using sound reproduction means, comprising:
detecting a main direction of emission of the sound signals emitted by the sound source in a time variable manner and a reproduction taking place in a manner dependent on the detected main direction of emission, wherein the reproduction of the sound signals takes place using a first reproduction unit associated with the sound source and at least one second reproduction unit spaced apart from the first reproduction unit, and the reproduction takes place with the second reproduction unit or units with time delays τ relative to the first reproduction unit.

18. The method according to claim 17, wherein the sound signals of the sound source are recorded by a sound recording means, and the main direction of emission of the emitted sound signals is detected by means for detecting direction.

19. The method according to claim 18, wherein the means for detecting direction are of an acoustic type.

20. The method according to claim 18, wherein the means for detecting direction are of an optical type.

21. The method according to claim 17, wherein the position of the first reproduction unit in the area of reproduction corresponds to a virtual position of the sound source in the area of reproduction.

22. The method according to claim 17, wherein the time delays τ are chosen in such a way that the time delays between the sound signals at least in sub-regions of the area of reproduction lie between 2 ms and 100 ms, preferably between 5 ms and 80 ms and in particular between 10 ms and 40 ms.

23. The method according to claim 17, wherein the reproduction using the first and/or the second reproduction unit(s) is carried out at a reduced level, in particular at a level reduced by 1 to 6 dB and preferably by 2 to 4 dB, and/or in particular depending on the main direction of emission.

24. The method according to claim 17, wherein the reproduction units are loudspeakers or a group of loudspeakers, a loudspeaker array or a combination thereof or a virtual source, in particular a virtual source generated by wave field synthesis.

25. The method according to claim 17, wherein the sound signals of multiple sound sources arranged in the recording space are recorded and are reproduced in the area of reproduction.

26. The method according to claim 25, wherein the sound recording means are associated with each sound source.

27. The method according to claim 26, wherein the sound signals from a sound source which are received by recording means that are not associated with the sound source, are suppressed using acoustic echo cancellation or cross talk cancellation.

28. A system for recording sound signals from one or more sound sources with time variable directional characteristics with sound recording means in a recording space and for reproducing the sound signals with sound reproduction means in an area of reproduction, the system comprising a means for detecting, in a time dependent manner, the main directions of emission of the sound signals emitted by the sound source(s) and means for reproducing the transmitted sound signals in dependence on the detected directions.

29. The system according to claim 28, wherein the system has at least two sound recording units associated with a sound source for recording the sound signals emitted by this sound source and the main direction of emission thereof.

30. The system according to claim 28, wherein the system has at least one sound recording unit associated with a sound source for recording the sound signals emitted by this sound source and optical means for detecting the main direction of emission thereof.

31. The system according to claim 28, wherein the number of the sound recording units and/or sound reproduction units corresponds to the number of the sound sources plus 2.

32. The system according to claim 28, wherein the sound reproduction units are a loudspeaker or a group of loudspeakers, a loudspeaker array or a combination thereof or a virtual source.

33. The method according to claim 19, wherein the acoustic type means for detecting direction comprise microphones and/or one or more microphone arrays.

34. The method according to claim 20 wherein the optical type means for detecting direction comprises a video detection process with pattern recognition.

35. The system according to claims 32, wherein the virtual source is generated by wave field synthesis.
